(19) United States
(12) Patent Application Publication
(10) Pub. No.: US 2024/0257801 A1
(43) Pub. Date: Aug. 1, 2024

(54) METHOD AND SYSTEM FOR CREATING A PROSODIC SCRIPT

(71) Applicant: SRI International, Menlo Park, CA (US)

(72) Inventors: Jeffrey LUBIN, Princeton, NJ (US); Alexander ERDMANN, Malvern, OH (US); James BERGEN, Pennington, NJ (US); Harry BRATT, Mountain View, CA (US); Jihua HUANG, Santa Clara, CA (US); Sarah BAKST, San Francisco, CA (US); Michael LOMNITZ, Castro Valley, CA (US); Zachary DANIELS, Robbinsville, NJ (US); John CADIGAN, San Diego, CA (US); Ali CHAUDHRY, Princeton Junction, NJ (US); Zhiwei ZHU, Princeton, NJ (US); Joshua CHATTIN, Mount Laurel, NJ (US); Girish ACHARYA, Redwood City, CA (US)

(21) Appl. No.: 18/393,575

(22) Filed: Dec. 21, 2023

Related U.S. Application Data
(60) Provisional application No. 63/442,673, filed on Feb. 1, 2023.
(60) Provisional application No. 63/454,575, filed on Mar. 24, 2023.

(51) Int. Cl. G10L 15/18; G10L 15/02; G10L 15/06; G10L 15/183; G10L 15/25; G10L 25/18

(52) U.S. Cl. CPC G10L 15/1807; G10L 15/02; G10L 15/063; G10L 15/183; G10L 15/25; G10L 25/18

(57) ABSTRACT

A method, apparatus, and system for creating a script for rendering audio and/or video streams include identifying at least one prosodic speech feature in a received audio stream and/or a received language model, creating a respective prosodic speech symbol for each of the at least one identified prosodic speech features, converting the received audio stream and/or the received language model into a text stream, temporally inserting the created at least one prosodic speech symbol into the text stream, identifying in a received video stream at least one prosodic gesture of at least a portion of a body of a speaker of the received audio stream, creating at least one respective gesture symbol for each of the at least one identified prosodic gestures, and temporally inserting the created at least one gesture symbol into the text stream along with the at least one prosodic speech symbol to create a prosodic script.

### CROSS-REFERENCE TO RELATED APPLICATIONS

This application claims benefit of and priority to U.S. Provisional Patent Application Ser. No. 63/442,673, filed Feb. 2, 2023 and U.S. Provisional Patent Application Ser. No. 63/454,575, filed Apr. 13, 2023, which are both herein incorporated by reference in their entireties.

### GOVERNMENT RIGHTS

This invention was made with Government support under contract number H92401-22-9-P001 awarded by the United States Special Operations Command (USSOCOM). The Government has certain rights in this invention.

### FIELD OF THE INVENTION

Embodiments of the present principles generally relate to content rendering and, more particularly, to a method, apparatus and system for creating a prosodic script for accurate rendering of content.

### BACKGROUND

Currently, there is no way for text-to-speech (TTS) and other behavioral rendering systems to reliably solve the “one-to-many” mapping problem, in which the rendering system attempts to create one rendering that covers all the different ways an individual may choose to speak a phrase, with the results that the current renderings tend to sound lifeless and without full communicative intent. Some current systems have begun to attempt post-hoc changes to spoken speech to address the “one-to-many” mapping problem, however, such solutions are cumbersome and unreliable.

On the other hand, the ability to realistically render a single frame of video, given puppeteering input or other means of specifying the position of human gestures, such as facial features, for that frame, has grown significantly, and there are now numerous means to generate these frames. Similarly, for speech, given a desired stream of phonemes (i.e., derived from text and a pronunciation dictionary), numerous methods exist to (a) quickly train a system to render a voice with the timbre of the desired output, and (b) render any desired text in that voice. However, for both face and voice, the ability to accurately render realistic behavioral dynamics for the selected subject has lagged far behind. For example, given only text as input, current systems are able to render speech for that input, but the speech generally comes across as without any real effect or intent, sounding much like an unengaged voice actor reading a script in a voice with only the minimal inflection needed to convey the syntax and semantics of the selected sentence. For face, the problem is in some ways worse, as face and head movements and expressions are generally completely divorced from any coordinated prosodic intent with the speech, a tell-tale sign of fakery, and a method guaranteed to disengage the listener.

### SUMMARY

Embodiments of the present principles provide a method, apparatus and system for prosodic scripting for accurate rendering of content.

In some embodiments, a method for creating a script for rendering audio and/or video streams includes identifying at least one prosodic speech feature, in a received audio stream and/or a received language model, and/or identifying at least one prosodic gesture in a received video stream, and automatically temporally annotating an associated text stream with at least one prosodic speech symbol created from the identified at least one prosodic speech feature and/or at least one prosodic gesture symbol created from the identified at least prosodic gesture to create a prosodic script, that when rendered provides an audio stream and/or a video stream comprising the at least one prosodic speech feature and/or the at least one prosodic gesture that are temporally aligned.

In some embodiments, the method can further include converting a received audio stream and/or a received language model into a text stream to create the associated text stream and creating the at least one prosodic speech symbol and/or the at least one prosodic gesture symbol using stored, pre-determined symbols.

In some embodiments, the method can further include rendering the prosodic script to create at least one predicted audio stream and/or at least one predicted video stream and comparing prosodic speech features of the at least one predicted audio stream and/or prosodic gestures of the at least one predicted video stream to prosodic speech features of a ground truth audio stream and/or prosodic gestures of a ground truth video stream to determine respective loss functions for training a system to create the prosodic script.

In some embodiments, in the method the prosodic gestures are identified from movement of at least a portion of a body of a speaker of the received audio stream.

In some embodiments, in the method the portion of a body of a speaker comprises a face of the speaker of the audio stream and that at least one prosodic gesture comprises a change in at least a portion of the face of the speaker, including at least one of a head, mouth, forehead, ears, chin, or eyes of the speaker of the received audio stream.

In some embodiments, the method can further include creating a spectrogram of the received audio stream, rendering the spectrogram from the prosodic script to create a predicted spectrogram, and comparing the predicted spectrogram to the created spectrogram to determine a loss function for training a system to create the prosodic script.

In some embodiments, in the method the at least one prosodic speech feature comprises at least one of an emphasis, a duration, or a pitch of a temporal portion of the received audio stream.

In some embodiments of the present principles, a method for creating a dynamic prosodic script for rendering audio and/or video streams includes identifying at least one prosodic speech feature in a received audio stream and/or a received language model, creating at least one modifiable prosodic speech symbol for each of the identified at least one prosodic speech features, converting the received audio stream into a text stream, automatically and temporally annotating the text stream with at least one created, modifiable prosodic speech symbol, identifying in a received video stream at least one prosodic gesture of at least a portion of a body of a speaker of the received audio stream, creating at least one modifiable prosodic gesture symbol for each of the identified at least one prosodic gestures and temporally annotating the text stream with at least one created, modifiable prosodic gesture symbol along with the at least one modifiable, prosodic speech symbol to create a prosodic script, wherein the at least one modifiable speech prosodic symbol and the at least one modifiable prosodic gesture symbol are modifiable in the prosodic script, such that a rendering of an audio stream or a video stream from the prosodic script is changed when at least one of the at least one modifiable speech prosodic symbol and the at least one modifiable prosodic gesture symbol is modified.

In some embodiments, in the above method at least one of the at least one prosodic speech symbol or the at least one prosodic gesture symbol comprise at least one of a predetermined character representative of at least one of the prosodic speech features identified in the audio stream or at least one of the prosodic gestures identified in the video stream or a semantic description of at least one of the prosodic speech features identified in the audio stream or at least one of the prosodic gestures identified in the video stream.

In some embodiments, an apparatus for creating a script for rendering audio and/or video streams includes a processor and a memory accessible to the processor, the memory having stored therein at least one of programs or instructions executable by the processor to configure the apparatus to identify at least one prosodic speech feature in a received audio stream and/or a received language model and/or at least identifying one prosodic gesture in a received video stream, and automatically temporally annotate an associated text stream with at least one prosodic speech symbol created from the identified at least one prosodic speech feature and/or at least one prosodic gesture symbol created from the identified at least prosodic gesture to create a prosodic script, that when rendered provides an audio stream and/or a video stream comprising the at least one prosodic speech feature and/or the at least one prosodic gesture that are temporally aligned.

In some embodiments, the apparatus is further configured to convert a received audio stream and/or a received language model into a text stream to create the associated text stream, and create the at least one prosodic speech symbol and/or the at least one prosodic gesture symbol using stored, pre-determined symbols.

In some embodiments, the apparatus is further configured to render the prosodic script to create at least one predicted audio stream and/or at least one predicted video stream and compare prosodic speech features of the at least one predicted audio stream and/or prosodic gestures of the at least one predicted video stream to prosodic speech features of a ground truth audio stream and/or prosodic gestures of a ground truth video stream to determine respective loss functions for training a system to create the prosodic script.

In some embodiments, the prosodic gestures are identified from movement of at least a portion of a body of a speaker of the received audio stream.

In some embodiments, the portion of a body of a speaker comprises a face of the speaker of the audio stream and that at least one prosodic gesture comprises a change in at least a portion of the face of the speaker, including at least one of a head, mouth, forehead, ears, chin, or eyes of the speaker of the received audio stream.

In some embodiments, the apparatus is further configured to create a spectrogram of the received audio stream, render the spectrogram from the prosodic script to create a predicted spectrogram, and compare the predicted spectrogram to the created spectrogram to determine a loss function for training a system to create the prosodic script.

In some embodiments, the at least one prosodic speech feature comprises at least one of an emphasis, a duration, or a pitch of a temporal portion of the received audio stream.

In some embodiments, a system for creating a script for rendering audio and/or video streams includes a spectral features module, a gesture features module, a streams to script module, and an apparatus comprising a processor and a memory accessible to the processor, the memory having stored therein at least one of programs or instructions. In such embodiments, when the programs or instructions are executed by the processor, the apparatus is configured to identify, using the spectral features module and/or the gesture features module, at least one prosodic speech feature in a received audio stream and/or a received language model and/or identifying at least one prosodic gesture in a received video stream, and automatically and temporally annotate, using the streams to script module, an associated text stream with at least one prosodic speech symbol created from the identified at least one prosodic speech feature and/or at least one prosodic gesture symbol created from the identified at least prosodic gesture to create a prosodic script, that when rendered provides an audio stream and/or a video stream comprising the at least one prosodic speech feature and/or the at least one prosodic gesture that are temporally aligned.

In some embodiments, the system further includes a speech to text module and the apparatus is further configured to convert, using the speech to text module, a received audio stream into a text stream to create the associated text stream, and create, using the streams to script module, the at least one prosodic speech symbol and/or the at least one prosodic gesture symbol using stored, pre-determined symbols.

In some embodiments, the system further includes a rendering module and the apparatus is further configured to render, using the rendering module, the prosodic script to create at least one predicted audio stream and/or at least one predicted video stream, and compare, using the rendering module, prosodic speech features of the at least one predicted audio stream and/or prosodic gestures of the at least one predicted video stream to prosodic speech features of a ground truth audio stream and/or prosodic gestures of a ground truth video stream to determine respective loss functions for training a system to create the prosodic script.

In some embodiments, the prosodic gestures are identified, by the streams to script module, from movement of at least a portion of a body of a speaker of the received audio stream.

In some embodiments, the portion of a body of a speaker includes a face of the speaker of the audio stream and that at least one prosodic gesture includes a change in at least a portion of the face of the speaker, including at least one of a head, mouth, forehead, ears, chin, or eyes of the speaker of the received audio stream.

In some embodiments, the apparatus is further configured to create a spectrogram of the received audio stream, render the spectrogram from the prosodic script to create a predicted spectrogram, and compare the predicted spectrogram to the created spectrogram to determine a loss function for training a system to create the prosodic script.

In some embodiments, the at least one prosodic speech feature comprises at least one of an emphasis, a duration, or a pitch of a temporal portion of the received audio stream.

Other and further embodiments in accordance with the present principles are described below.

### BRIEF DESCRIPTION OF THE DRAWINGS

So that the manner in which the above recited features of the present principles can be understood in detail, a more particular description of the principles, briefly summarized above, may be had by reference to embodiments, some of which are illustrated in the appended drawings. It is to be noted, however, that the appended drawings illustrate only typical embodiments in accordance with the present principles and are therefore not to be considered limiting of its scope, for the principles may admit to other equally effective embodiments.

FIG. 1 depicts a high-level block diagram of a prosodic scripting system 100 in accordance with an embodiment of the present principles.

FIG. 2A depicts a listing of exemplary symbols that are representative of prosodic speech features in accordance with an embodiment of the present principles.

FIG. 2B depicts examples of the insertion of prosodic symbols into a text stream in accordance with an embodiment of the present principles.

FIG. 2C depicts a table including facial modulations encoded as blend-shape coefficients that can already have semantic descriptions and/or symbols associated in accordance with an embodiment of the present principles.

FIG. 3 depicts a high-level block diagram of an architecture of a speech and sketch prediction module in accordance with an embodiment of the present principles.

FIG. 4 depicts a high-level block diagram of a different architecture of the speech and sketch prediction module in accordance with an alternate embodiment of the present principles.

FIG. 5 depicts a high-level block diagram of yet an alternate architecture of the speech and sketch prediction module in accordance with an alternate embodiment of the present principles.

FIG. 6 depicts a flow diagram of a method for prosodic scripting in accordance with an embodiment of the present principles.

FIG. 7 depicts a high-level block diagram of a computing device suitable for use with a prosodic scripting system in accordance with embodiments of the present principles.

FIG. 8 depicts a high-level block diagram of a network in which embodiments of a prosodic scripting system in accordance with the present principles can be applied.

FIG. 9 depicts a pictorial representation of a user interface that can be implemented with a prosodic scripting system of FIG. 1 in accordance with an embodiment of the present principles.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present principles generally relate to methods, apparatuses and systems for prosodic scripting for accurate rendering of content. While the concepts of the present principles are susceptible to various modifications and alternative forms, specific embodiments thereof are shown by way of example in the drawings and are described in detail below. It should be understood that there is no intent to limit the concepts of the present principles to the particular forms disclosed. On the contrary, the intent is to cover all modifications, equivalents, and alternatives consistent with the present principles and the appended claims. For example, although embodiments of the present principles will be described primarily with respect to specific content such as facial features, such teachings should not be considered limiting. Embodiments in accordance with the present principles can be applied to substantially any content including other human body parts and robotic components.

Embodiments of the present principles enable an automatic extraction of prosodic elements from video and audio capture of visual and audio performances, such as spontaneously speaking humans. The prosodic text/audio and gesture annotations are scripted and such script can be rendered to for example; train a prosodic scripting system of the present principles based on predicting prosody streams from the scripted text including the prosodic annotations, which can be used for behavioral analysis and feedback. Such analysis and feedback of the present principles can be implemented to, for example, enable an understanding of distinct components of a large-scale scene, such as a 3D scene, and the contextual interactions between such components can provide a better understanding of the scene contents and to enable a segmentation of the scene into various semantic categories of interest.

The term “symbol” is used throughout this disclosure. It should be noted that the term “symbol” is intended to define any representation of at least one of prosodic speech features and/or prosodic gestures that can be inserted/annotated in a text stream in accordance with the present principles. For example and as described below, in some embodiments a symbol can include a character that is representative of at least one of prosodic speech features and/or prosodic gestures that can be inserted/annotated in an associated text stream. Alternatively or in addition, in some embodiments a symbol can include a semantic description (e.g., text) of at least one of prosodic speech features and/or prosodic gestures that can be inserted/annotated in an associated text stream.

Prosody can be defined as behavioral dynamics which can include the communication of meaning beyond what is included in actual words and gestures. That is, prosody refers to modulations of spoken speech, e.g., with pauses, emphases, rising and falling tones, etc, and human gestures (e.g., facial gestures) and mannerisms that are also synchronized to the spoken content. As such, in the present disclosure, a prosodic audio/speech feature can refer to parts/features of audio/speech that communicate meaning beyond the actual words and a prosodic gesture can include any expression and/or movement of a body (human or otherwise) that communicate meaning beyond temporally respective words.

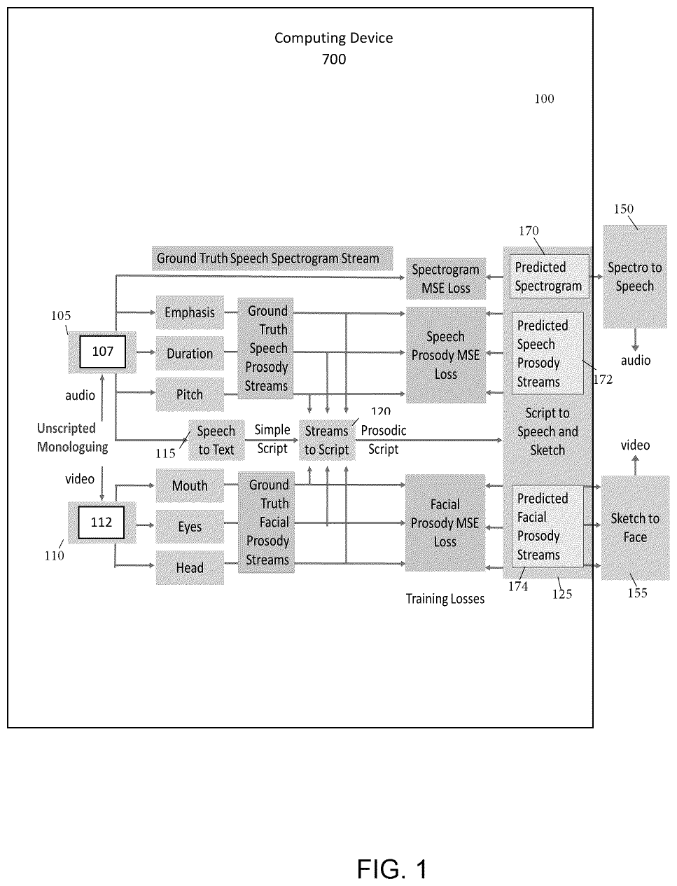

Although embodiments of the present principles will be described herein with respect to receiving audio and video data of a human performing an act, such as reading a monologue, alternatively or in addition, embodiments of a prosodic scripting system of the present principles, such as the prosodic scripting system 100 of FIG. 1, can receive as in input a pre-trained large language model (LLM) that can be trained with a specific style of speaking/audio and/or a specific style of body gesture. As such, a prosodic scripting system of the present principles can determine a prosodic script in accordance with the present principles using an LLM as an input.

In accordance with embodiments of the present principles, a text stream is temporally annotated at least one prosodic speech symbol created from at least one prosodic speech feature identified in a received audio stream and/or at least one prosodic gesture symbol created from at least prosodic gesture identified in a received video stream to create a prosodic script. Because the prosodic speech symbols and/or the prosodic gesture symbols are temporally inserted into the text stream, a rendered prosodic script will accurately reflect in time, a predicted audio performance of the received audio stream, and/or a predicted visual performance of the received video stream, and/or a coordinated performance of the received audio and video stream.

FIG. 1 depicts a high-level block diagram of a prosodic scripting system 100 in accordance with an embodiment of the present principles. The prosodic scripting system 100 of FIG. 1 illustratively comprises a spectral features module 105, a visual features module 110 (illustratively a facial features module), a speech to text module 115, a streams to script module 120, and a script to speech and a sketch prediction module 125. As depicted in FIG. 1, embodiments of a prosodic scripting system of the present principles, such as the prosodic scripting system 100 of FIG. 1, can be implemented in a computing device 700 (described in greater detail below). Although in the embodiment of FIG. 1, the computing device 700 appears to be a single computing device, in embodiments of the present principles, a computing device of the present principles, such as the computing device 700 of FIG. 1 can comprise more than one computing device.

In the embodiment of the prosodic scripting system 100 of FIG. 1, the spectral features module 105 receives audio of, for example, a person speaking, such as the unscripted monologuing by a human. Although the embodiment of FIG. 1 is depicted as receiving an audio input including the unscripted monologuing by a human, as described above, in alternate embodiments of the present principles, the prosodic scripting system 100 of FIG. 1 can receive as in input, a pre-trained LLM.

In some embodiments of the present principles, the prosodic scripting system 100 of FIG. 1 can receive audio from an audio recording device (not shown), such as a digital recording device, or any audio recording device from which a spectrogram can be derived. In the embodiment of the prosodic scripting system 100 of FIG. 1, the spectral features module 105 can extract prosodic audio/speech features, such as emphasis, duration and pitch, from the received audio. For example, in some embodiments, the spectral features module 105 can include feature extraction module 107 that can include a machine learning system that is trained to learn, for example, normal/typical/mean values of audio features over time, such that a deviation of that normal/typical/mean value (i.e., of statistical significance) can be considered a prosodic feature of received audio. In some embodiments of the present principles and as depicted in the prosodic scripting system 100 of FIG. 1, the spectral features module 105 can additionally create a speech spectrogram of the received audio. In such embodiments, alternatively or in addition, a determined spectrogram derived from received audio can be monitored to identify audio events that are outside of a normal/typical/mean value to identify prosodic features of the audio. In general, in accordance with the present principles, the spectral features module 105 can extract from the received audio, any perceivable behavior that modulates the meaning of the spoken words, defined as prosodic features. In some embodiments, a prosodic scripting system of the present principles, such as the prosodic scripting system 100 of FIG. 1, can implement a threshold above and/or under which an amount of deviation must be to be considered a prosodic event/feature. The temporal streams of prosodic speech features determined by the spectral features module 105 can then be communicated to the streams to script module 120.

In the embodiment of the prosodic scripting system 100 of FIG. 1, a copy of the audio is also communicated to the speech to text module 115. The speech to text module 115 converts the received audio to text, which can then be communicated to the streams to script module 120.

In the embodiment of the prosodic scripting system 100 of FIG. 1, the streams to script module 120 receives as an input from, for example, the spectral features module 105, temporal streams of scalar prosodic features, generated at the temporal resolution of the spectral feature computation (i.e., the generation of a speech spectrogram). In the embodiment of FIG. 1, the streams to script module 120 can create a respective symbol for each of the identified prosodic features in the received stream, such that the symbol describes the prosodic feature/event. For example in some embodiments, a created symbol can describe semantically features of each prosodic feature/event, such as the approximate duration and magnitude of each prosodic feature/event. Alternatively or in addition, in some embodiments, a created symbol can include a character representative of features of each prosodic feature/event. In some embodiments, such characters can be predetermined and stored in a memory accessible by and/or associated with a streams to script module of the present principles, such as the streams to script module 120 of FIG. 1. In such embodiments, when the streams to script module 120 receives an identified prosodic feature, the streams to script module 120 can select a representative, previously created symbol, from, for example, an associated storage device in which the symbols are stored, to represent the respective prosodic feature.

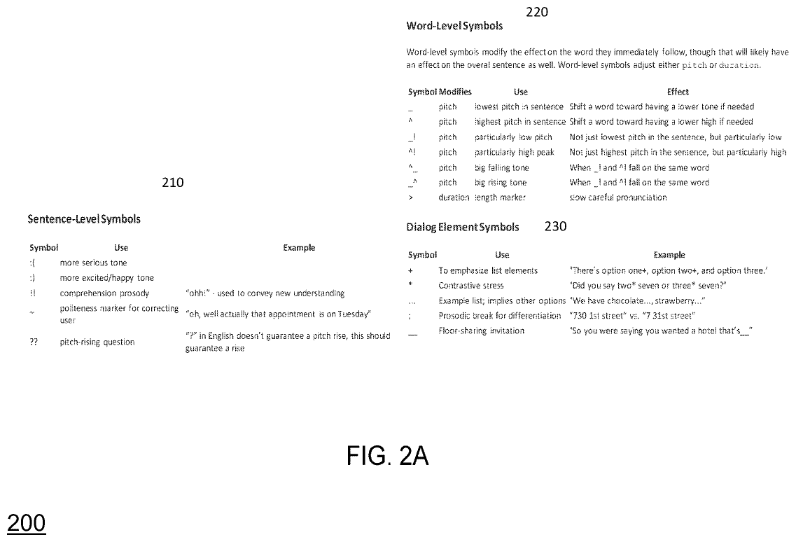

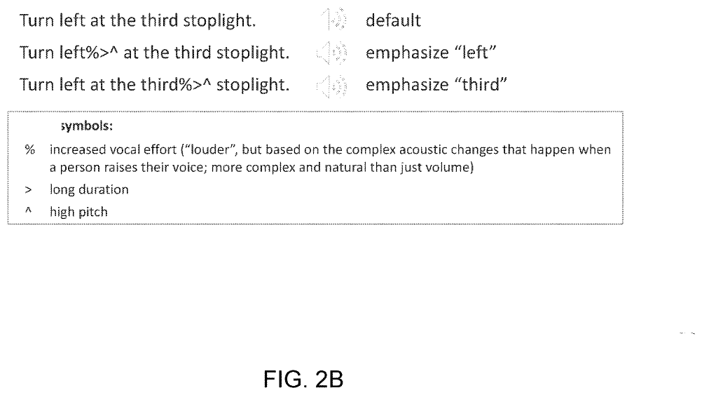

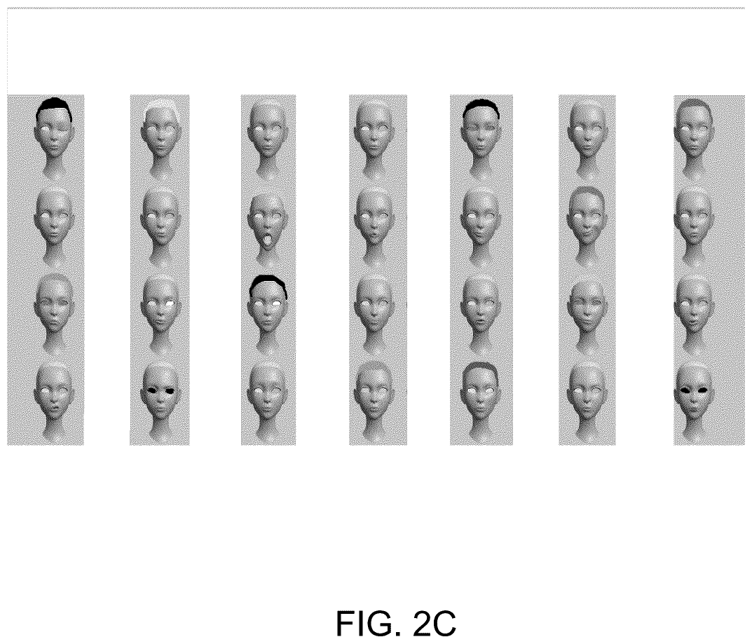

For example, FIG. 2A depicts a listing 200 of some exemplary symbols that can be created by devices of the present principles, such as the streams to script module 120, that are representative of prosodic speech features in, for example, a received stream in accordance with an embodiment of the present principles. As depicted in the listing 200 of FIG. 2A, symbols can include, but are not limited to, sentence-level symbols 210, word-level symbols 220 and dialog-element symbols 230. In the embodiment of FIG. 2A, the sentence-level symbols 210 can include indicators of a tone of a sentence, illustratively a smiley face or a frowny face. In the embodiment of FIG. 2A, the word-level symbols 220 can include indicators of a pitch and/or duration of a word. Even further, in the embodiment of FIG. 2A, dialog-element symbols 230 can include indicators used to emphasize elements in a list of elements, indicators used to show contrastive stress between elements in a sentence, indicators used to provide prosodic breaks between words in a sentence for differentiation between words, and the like.

Referring back to the embodiment of the prosodic scripting system 100 of FIG. 1, the streams to script module 120 can further receive as an input, a text stream of the captured audio from which the speech spectrogram was created from, for example, the speech to text module 115. The streams to script module 120 can insert the created symbols into the text stream received from the speech to text module 115. The result is a “Prosodic Script” 150. By including the prosodic features symbolically in the input text stream, embodiments of the present principles enable the learning of appropriate modulations for each speaker and prosodic intent with high rendering accuracy.

For example, FIG. 2B depicts examples of the insertion of prosodic symbols into a text stream in accordance with an embodiment of the present principles. That is, in FIG. 2B a default sentence, for example in a text stream, includes the words, “Turn left at the third stoplight”. In a first example, the default sentence is modified by annotating the sentence with prosodic symbols %>∧ after the word “left” to indicate that the word “left” should be emphasized based on a combination of vocal effort %, duration >, and pitch ∧ when rendering the sentence. In a second example in FIG. 2B, the default sentence is modified by annotating the sentence with prosodic symbols %>∧ after the word “right” to indicate that the word “right” should be emphasized based on a combination of vocal effort %, duration >, and pitch ∧ when rendering the sentence. That is, in accordance with the present principles, a text stream can be annotated, for example in the embodiment of the prosodic scripting system 100 of FIG. 1 by the streams to script module 120, with symbols representative of identified prosodic features. In some embodiments, a streams to script module of the present principles, such as the streams to script module 120 of FIG. 1, can automatically annotate a text stream with symbols representative of identified prosodic features.

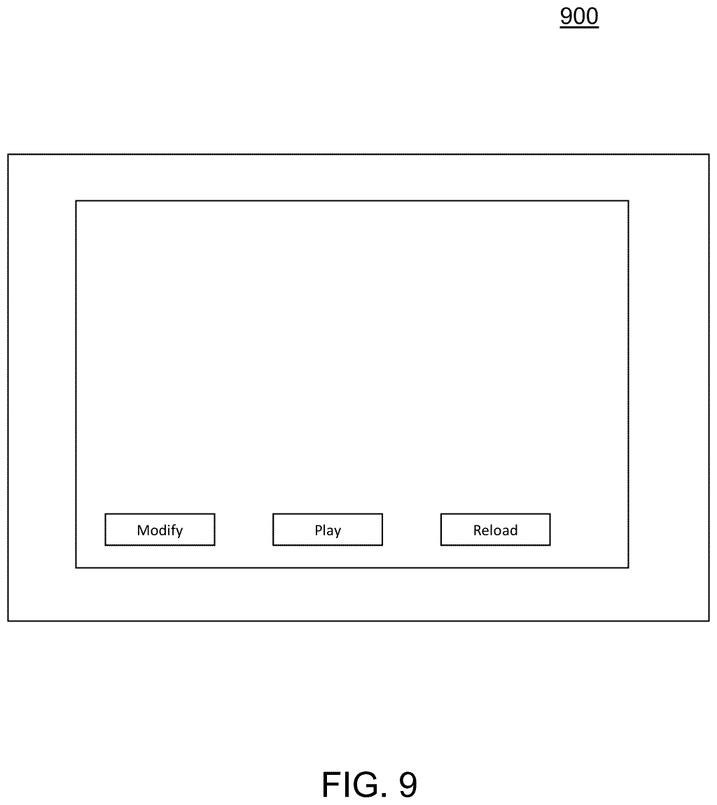

In accordance with the present principles, in some embodiments, the prosodic speech symbols inserted/annotated in the text stream can be modified/modifiable. That is, in some embodiments of the present principles, the symbols or any other representation of identified speech prosody can be modified in a created prosodic script, such that a rendering of the prosodic speech can be changed. That is, a rendering of a performance of a prosodic script can be changed by modifying prosodic symbols and/or semantic descriptions representative of identified prosodic speech that were inserted into a determined prosodic script (described in further detail with respect to FIG. 9).

In the prosodic scripting system 100 of FIG. 1, the Prosodic Script 150 is communicated to the text-to-speech and sketch prediction module 125 and provides to the text-to-speech and sketch prediction module 125 not only the words and punctuation needed to impart semantic, communicative content to an output, predicted speech, but also the prosodic information that modulates the speech, providing additional semantic meaning.

In the embodiment of the prosodic scripting system 100 of FIG. 1, the visual features module 110 receives video of the person speaking, for example, the unscripted monologue. In some embodiments of the present principles, the visual features module 110 can receive video from any video recording device including a Lidar sensor that can provide three-dimensional information of the speaker of, for example, the unscripted monologue. The visual features module 110 extracts images of the prosodic gestures of, for example, portions of a human body, for example a speaker's face. In some embodiments, prosodic gestures of a human face can include images of mouth position and movement, eye position and movement, forehead position and movement, ear position and movement, head position and movement, and the like, from the received video. That is, in the visual features module 110, the prosodic features are based, not on speech measures such as pitch and emphasis, but on expressive modulations of at least a portion of a body, such as a face, related to prosodic gestures including but not limited to the eyes (e.g., eyebrow raises), head, mouth (e.g., smiles, lip-pursing, etc.), ears, forehead, chin, arms, legs, and the like. More specifically, the visual features module 110 can extract from the received video any perceivable behavior that modulates the meaning of respective, spoken words.

Similar to the spectral features module 105 of FIG. 1, the visual features module 110 can include a feature extraction module 112 that can include a machine learning system that is trained to learn, for example, normal/typical/mean values of visual gestures over time, such that a deviation (i.e., of statistical significance) of that normal/typical/mean value can be considered a prosodic gesture in received video. For example, in some embodiments, the feature extraction module 112 of the visual features module can learn a normal/typical/mean position of the eyebrows of a speaker's face and any deviation from that normal/typical/mean position of the eyebrows can be considered a prosodic gesture. The same procedure can be applied to any human or non-human gesture of a speaker. In general, in accordance with the present principles, the visual features module 110 can extract from the received video, any perceivable behavior that modulates the meaning of the spoken words, defined as prosodic gestures. In some embodiments, a prosodic scripting system of the present principles, such as the prosodic scripting system 100 of FIG. 1, can implement a threshold above and/or under which an amount of deviation must be to be considered a prosodic event/gesture. The temporal streams of prosodic gestures determined by the visual features module 110 can then be communicated to the streams to script module 120.

That is, in the embodiment of the prosodic scripting system 100 of FIG. 1, the streams to script module 120 receives as an input from, for example, the visual features module 110, temporal streams of prosodic gestures, generated at the temporal resolution of the video. In the embodiment of FIG. 1, the streams to script module 120 can create a respective symbol for each of the identified prosodic gestures in the received stream, such that the symbol describes the prosodic gesture, such as describing semantically or providing a symbolic representation of an approximate movement of at least a portion of a human body or non-human body that is the source of the corresponding, received audio.

In some embodiments of the present principles, the streams to script module 120 can create a respective symbol for each of the identified prosodic gestures similar to the prosodic speech symbols depicted in FIG. 2A. The streams to script module 120 can insert the created symbols for the prosodic gestures into the text stream received from the speech to text module 115. The result is a “Prosodic Script” 150. By including the prosodic gestures symbolically in the input text stream, embodiments of the present principles enable the learning of appropriate gestures for at least a portion of the body of each speaker with high rendering accuracy.

In accordance with the present principles, in some embodiments, the prosodic gesture symbols inserted/annotated in the text stream can be modified/modifiable. That is, in some embodiments of the present principles, the symbols or any other representation of identified gesture prosody can be modified in a created prosodic script, such that a rendering of identified body gestures can be changed. That is, a rendering of a performance of a prosodic script can be changed by modifying prosodic gesture symbols and/or semantic descriptions representative of identified prosodic gestures that were inserted into a determined prosodic script (described in further detail with respect to FIG. 9).

In some embodiments of the present principles, the streams to script module 120 can implement pre-determined facial modulation models to determine at least one of a semantic description and/or symbols for the identified prosodic gestures of received video and accurately capture 3D head shape. For example, in some embodiments, the streams to script module 120 can attempt to match at least one prosodic gesture of a received temporal prosodic gesture stream received from, for example, the visual streams module 110, to attempt to determine at least one of a semantic description and/or a symbol for at least one identified prosodic gesture. The streams to script module 120 can then annotate the text stream with the determined semantic description and/or a symbol for the at least one identified prosodic gesture.

FIG. 2C depicts a table including facial modulations, in some embodiments encoded as blend-shape coefficients, that can be implemented by, for example, the streams to script module 120, to attempt to identify received prosodic facial gestures. That is, in the table of FIG. 2, there are depicted various facial modulations including different positions for different portions of a human face, including eyebrows, eyes, mouth, lips, ears, forehead and the like. In some embodiments, the facial modulations can already have respective semantic descriptions and/or symbols associated. In some embodiments, the streams to script module 120 can match a received prosodic gesture to at least one of the facial modulations and implement a respective semantic description and/or symbol associated with the matched facial modulation and annotate a received text stream with the associated semantic descriptions and/or symbol. That is, in some embodiments of the present principles, in the streams to script module 120, the streams of these coefficients can be reduced to two-parameter labels that approximate the duration and magnitude of prosodic actions and the labels can then be annotated into the prosodic script 150, determined by the streams to script module 120, at the appropriate positions. In some embodiments of the present principles, the facial modulations in the Table of FIG. 2 can include a blend of two or more facial modulations to represent a prosodic gesture.

Although the embodiment of the prosodic scripting system 100 of FIG. 1 is depicted as comprising both an audio stream received by the spectral features module 105 and a video stream received by the visual features module 110, in alternate embodiments of the present principles, a prosodic scripting system of the present principles can create a prosodic script of the present principles from a received audio stream. That is, in some embodiments, a spectral features module of the present principles can receive an audio stream and identify prosodic speech features of the received audio stream in accordance with the present principles and as similarly described in the embodiment of FIG. 1. A streams to script module of the present principles can then create a respective symbol for each of the identified prosodic speech features in accordance with the present principles and as similarly described in the embodiment of FIG. 1. In such embodiments, however, a prosodic script is created by temporally annotating an associated text stream with only the symbols created for each of the identified prosodic speech features. In such embodiments, the associated text stream can include a text stream representative of the received audio stream that can be received by a prosodic scripting system of the present principles from a user or other outside source or, similar to the embodiment of the prosodic scripting system 100 FIG. 1, can include a text stream that was created from the received audio stream by a speech to text module. In such embodiments, a prosodic script of the present principles is created by temporally annotating an associated text stream with only prosodic speech symbols created from/for the identified prosodic speech features in the received audio stream.

Alternatively, in some embodiments of the present principles, a prosodic scripting system of the present principles can create a prosodic script of the present principles from only a received video stream. That is, in some embodiments, a visual features module of the present principles can receive video stream and identify prosodic gestures in the received video stream in accordance with the present principles and as similarly described in the embodiment of FIG. 1. A streams to script module of the present principles can then create a respective symbol for each of the identified prosodic gestures in accordance with the present principles and as similarly described in the embodiment of FIG. 1. In such embodiments, however, a prosodic script is created by temporally annotating an associated text stream with only the symbols created for each of the identified prosodic gestures. In such embodiments, the associated text stream can include a text stream representative of an audio stream that is temporally related to prosodic gestures in the video stream, which can be received by a system of the present principles from a user or other outside source. In such embodiments, a prosodic script of the present principles is created by temporally annotating an associated text stream with only prosodic gesture symbols created from/for the identified prosodic gestures in the received video stream.

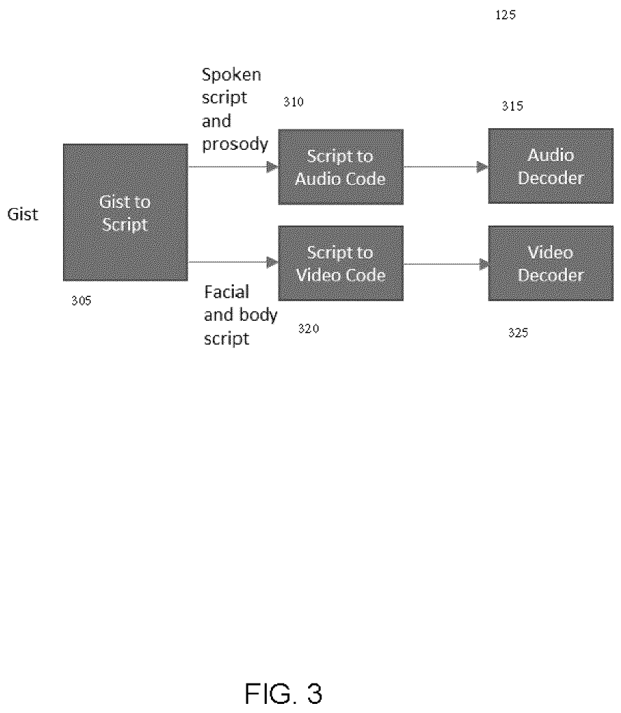

In a prosodic scripting system of the present principles, such as the embodiment of the prosodic scripting system 100 of FIG. 1, a prosodic script created in accordance with the present principles can be communicated to the script to speech and sketch prediction module 125 for rendering. FIG. 3 depicts a high-level block diagram of an architecture of the speech and sketch prediction module 125 in accordance with an embodiment of the present principles. In the embodiment of FIG. 3, the speech and sketch prediction module 125 can implement a gist-to-script architecture including a gist-to-script module 305, a script to audio code module (audio encoder) 310, an audio decoder module 315, a script to video code module (video encoder) 320, and a video decoder module 325. The gist-to-script module 305 can include a summary description of the intended communication to enable the gist-to-script module 305 to provide the gist-to-script module 305 a starting point to generate two scripts from, for example, the prosodic script received from the streams to script module 120 of the prosodic scripting system 100 of FIG. 1. In the embodiment of FIG. 3, the first generated script, referred to as the “spoken script and prosody script”, includes highly detailed descriptions of intended temporal dynamics governing prosody (i.e., including stresses, timings and tone changes over and within words and word sequences). The second generated script, referred to as the “Facial and Body Script”, includes time-synchronized sequences of facial expressions and gestures that are generated, just like speech prosody sequences, to clarify or modulate the spoken text.

In the embodiment of FIG. 3, the first script is communicated to the audio code module 310 and the second script is communicated to the video code module 320. The audio code module 310 and the video code module 320 transform the respective first and second scripts into streaming code sequences able to be decoded and rendered by the respective audio decoder 315 and video decoder 325. The respective code sequences transformed from the first and the second scripts are communicated to the respective audio decoder 315 and video decoder 325 to render a prediction of the audio and video content from the prosodic script. In some embodiments, the audio decoder 315 and video decoder 325 can be previously trained to render in the voice and body portion (e.g., face) of an intended synthetic person speaking.

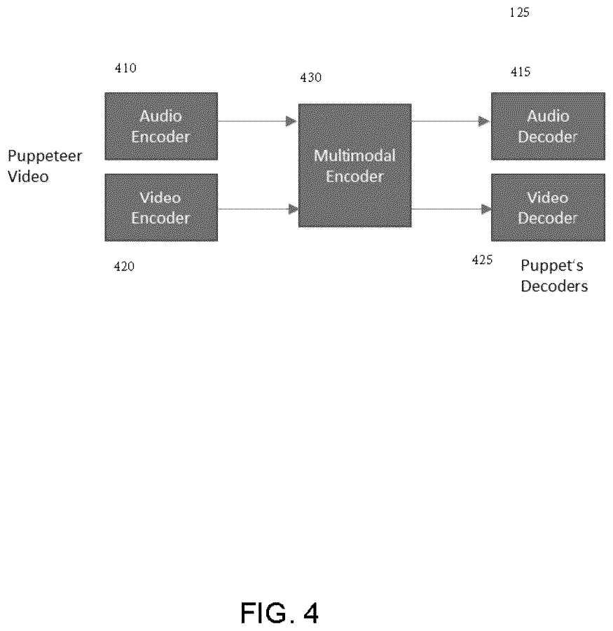

FIG. 4 depicts a high-level block diagram of a different architecture of the speech and sketch prediction module 125 in accordance with an alternate embodiment of the present principles. The speech and sketch prediction module 125 of FIG. 4 illustratively comprises an audio encoder module 410, a video encoder module 420, a multimodal encoder module 430, an audio decoder module 415, and a video decoder module 425. In the embodiment of FIG. 4, a prosodic script received from, for example, the streams to script module 120 of the prosodic scripting system 100 of FIG. 1, includes video with audio of at least one puppeteer (e.g., a human from whom sets of other outputs have been previously used for training). The audio component is communicated to the audio encoder module 410 and the video component is communicated to the video encoder module 420. The audio encoder module 410 and the video encoder module 420 transform the respective audio and video components into streaming code sequences, which are communicated to the multimodal encoder module 430. The output of the multimodal encoder module 430 is a temporal stream of codes, for both audio and video, that are designed to enable renderings in the face and voice of any individual from a pretrained set. The temporal stream of audio codes from the multimodal encoder module 430 is communicated to the audio decoder module 415 and the temporal stream of video codes is communicated to the video decoder module 425. In the embodiment of FIG. 4, the selected individual (the “puppet”) is instantiated in the audio decoder module 415 and the video decoder module 425, which have been previously trained for that individual. The temporal streams from the multimodal encoder module 430 can therefore be thought of as an individual-agnostic command sequence, for example, for any face and voice, that becomes a specific individual only via renderings through that individual's, pretrained audio and video decoders.

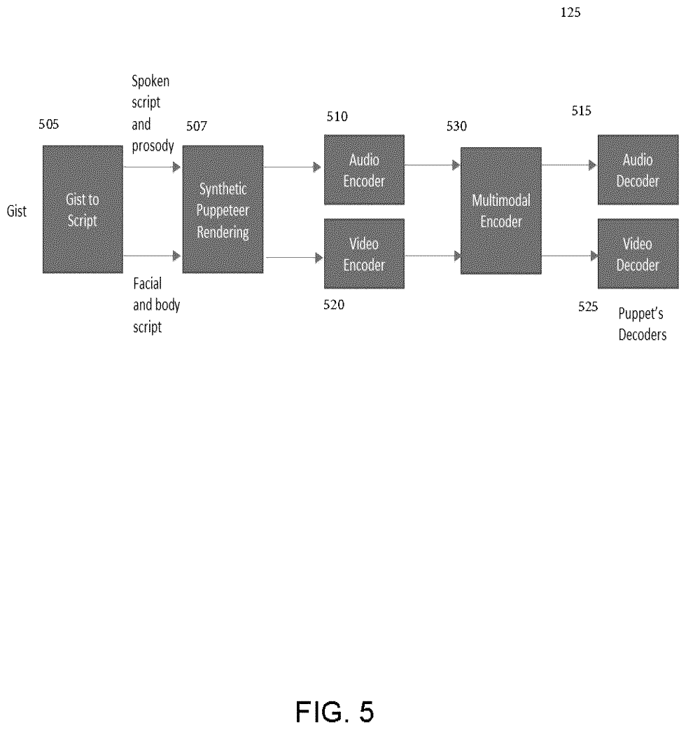

FIG. 5 depicts a high-level block diagram of yet an alternate architecture of the speech and sketch prediction module 125 in accordance with an alternate embodiment of the present principles. The embodiment of FIG. 5 combines the architectures of FIG. 3 and FIG. 4. More specifically, in the embodiment of FIG. 5, the speech and sketch prediction module 125 implements a gist-to-script architecture including a gist-to-script module 505, a synthetic puppeteer rendering module 507, an audio encoder module 510, an audio decoder module 515, a video encoder module 520, a video decoder module 525, and a multimodal encoder module 530. Similar to the embodiment of FIG. 3, the speech and sketch prediction module 125 of FIG. 5 can include a summary description of the intended communication to enable the gist-to-script module 505 to generate two scripts. In the embodiment of FIG. 5, the first generated script, referred to as the “spoken script and prosody script”, includes a traditional spoken script and highly detailed descriptions of intended temporal dynamics governing prosody (i.e., including stresses, timings and tone changes over and within words and word sequences). The second generated script, referred to as the “Facial and Body Script”, includes time-synchronized sequences of facial expressions and gestures that are generated, just like speech prosody sequences, to clarify or modulate the spoken text.

In the embodiment of FIG. 5, the first script and the second script are communicated to the synthetic puppeteer rendering module 507. The synthetic puppeteer rendering module 507 can include video with audio of at least one puppeteer (e.g., a human from whom sets of other outputs have been previously used for training) that can be applied to render the first script and the second script. That is, the synthetic puppeteer rendering module 507 can apply a synthetic puppeteer process to the first script and the second script as a means of forcing the audio encoder module 510 and the video encoder module 520 to generate the correct form of outputs. That is, the synthetic puppeteer process of the synthetic puppeteer rendering module 507 can be used to more optimally design the audio encoder module 510 and the video encoder module 520, for example, by training the audio encoder module 510 and the video encoder module 520 to perform CGI rendering directly into an autoencoder's code stream, rather than into the visual and audio domains.

In some embodiments, a synthetic puppeteer rendering module of the present principles, such as the synthetic puppeteer rendering module 507 of FIG. 5, can implement a face rendering technique, such as FaceGen, which contains a scripting language and existing finely crafted modeled elements and actions that enable realistic speech articulation and expression modulation.

In the embodiment of FIG. 5, the audio encoder module 510 and the video encoder module 520 transform the respective audio and video components into streaming code sequences, which are communicated to the multimodal encoder module 530. In the multimodal encoder module 530 of FIG. 5, the received streams can be thought of as a representation of the movements and speech of a kind of universal puppeteer. In fact, one brute-ish force way of dealing with the generation of these code streams is to actually render an attempt at a universal puppeteer, using standard CGI techniques, and then use this puppeteer as input to the autoencoders. In such an embodiment, the scripts output from gist-to-script module 505 would be used to directly control the CGI puppeteer, using for example text-to-speech, and lip, face and head motions and gestures. This puppeteer's outputs would then go into the multimodal autoencoder which had been previously trained to convert this puppeteer's video and audio to that of the selected puppet. In such an embodiment, this method produces the exact codes that are needed as output from the modules Script-to-Audio-Code and Script-to-Video-Code.

Referring back to the embodiment of FIG. 5, the output of the multimodal encoder module 530 is a temporal stream of codes, for both audio and video, that are designed to enable renderings in the face and voice of any individual from, for example, a pretrained set. The temporal stream of audio codes from the multimodal encoder module 530 is communicated to the audio decoder module 515 and the temporal stream of video codes is communicated to the video decoder module 525. In some instances in the embodiment of FIG. 5, the selected individual (the “puppet”) can instantiated in the audio decoder module 515 and the video decoder module 525, which have been previously trained for that individual.

The embodiment of the speech and sketch prediction module 125 of FIG. 5 combines the gist first system architecture and capabilities of the embodiment of FIG. 3 with the “puppeteer” and the multimodal autoencoder architecture and capabilities of the embodiment of FIG. 4 to construct a complete, versatile rendering system architecture. For example, the embodiment of FIG. 5 combines the “mass production” purposes a gist-based system of the embodiment of FIG. 3 with the ease of control by a good puppeteer of the embodiment of FIG. 4. As depicted in the embodiment of FIG. 5, the human readability of the outputs of the Gist-to-Script system can be used as script materials by a puppeteer module. Alternatively, in some embodiments, the gist-based generation of scripts can be eliminated and replaced by human-crafted scripts, which can then be used either by human puppeteers or by the system of the embodiment of FIG. 3. The embodiment of FIG. 5 enables the separation of modeling the relatively simple, short time-scale features of an individual's face and voice within the short (approximately one-second) temporal windows of the individuals' decoders, reserving the more challenging, longer time-scale features of an individual's word choice, prosody, and repertoire of facial expressions and gestures to the Gist-to-Script module.

Referring back to the prosodic scripting system 100 of FIG. 1, the output of the script to speech and sketch prediction module 125 can include at least a predicted spectrogram 170, a predicted speech prosody stream 172, and a predicted facial prosody stream 174. In the prosodic scripting system 100 of FIG. 1, training losses can be determined based on differences between a ground-truth spectrogram and the predicted spectrogram stream 170, as well as on differences between ground-truth and predicted speech prosody 172 and facial prosody 174 streams. In accordance with the present principles, the use of prosodic features as conditioning signals for text-to-speech training helps organize the trained network along prosodically relevant dimensions and helps improve the speed and accuracy of training of a prosodic scripting system of the present principles, such as the prosodic scripting system 100 of FIG. 1.

As depicted in the embodiment of the prosodic scripting system 100 of FIG. 1, the output of the script to speech and sketch prediction module 125 can alternatively or in addition be communicated to a spectro to speech module 150 and a sketch to face module 155.

In some embodiments of the present principles, the spectro to speech module 150 can provide a spectrogram stream, which is converted to a speech waveform for final output. For facial rendering, the sketch to face module 155 can provide a sketch-like rendering to indicate positions of facial features within each frame of the face. In some embodiments, the sketch to face module 155 can include a multi-frame, multimodal autoencoder, that is trained to render the mesh as a specific, fully “fleshed out” face.

In some embodiments of the present principles, in the script to speech and sketch prediction module 125, synchronization of the speech and facial prosody can be achieved in a number of different ways. That is, a tightest synchronization is required for the lips of a speaker, and a script to speech and sketch prediction module of the present principles can, in some embodiments, implement a FaceFormer process that takes as input the already rendered speech stream, thus giving speech the appropriate and needed control for the synchronization.

Although in the embodiment of a prosodic scripting system 100 of FIG. 1, the Prosodic Script is generated automatically during training, in some embodiments, for rendering the automatically generated Prosodic Script, a two-step process can be implemented under flexible control by a user. In such an embodiment, in a first step, a default Prosodic Script for an individual rendered subject can be generated from a simple text script using a separate module (not shown in FIG. 1) for example in the script to speech and sketch prediction module 125, that can be trained using a language rendering model, such as a Roberta Large Model, to augment the individual's Simple Script, derived from actual speech/video samples from that individual, to predict the automatically generated Prosodic Script derived from the same samples. This feature allows the user at runtime to input desired text and have the system generate an appropriate Prosodic Script that instantiates the speaking style of a selected individual. Then, in a second step, using a user interface (described in greater detail below), the default rendering can be fine-tuned to better incorporate desired semantic nuances in a rendering of the individual's speech and behavior.

FIG. 9 depicts a pictorial representation of a user interface 900 that can be implemented with a prosodic scripting system of the present principles, such as the prosodic scripting system 100 of FIG. 1 to fine-tune a scripted performance by enabling a user to fine tune a rendered prosodic script by adjustment of the various prosody features in a created Prosodic script. The user interface 900 of FIG. 9 illustratively comprises a Modify feature, which enables a user to add and/or modify symbols or semantic descriptions of at least one of prosodic speech features and/or prosodic gestures inserted in, for example, a prosodic script in accordance with the present principles. The user interface 900 of FIG. 9 further includes a Play feature, which enables a user to render a prosodic script, for example, after making changes to a prosodic script in accordance with the present principles. In some embodiments, the Play feature can also be used to render a new prosodic script that has been generated in accordance with the present principles. The user interface 900 of FIG. 9 further includes a Reload feature, which can be used to reload an original file, for example, to reverse any changes mad to a prosodic script. In some embodiments of the present principles, the user interface 900 of FIG. 9 can comprise a component related to the computing device 700 and can display results in a display device associated with the computing device 700.

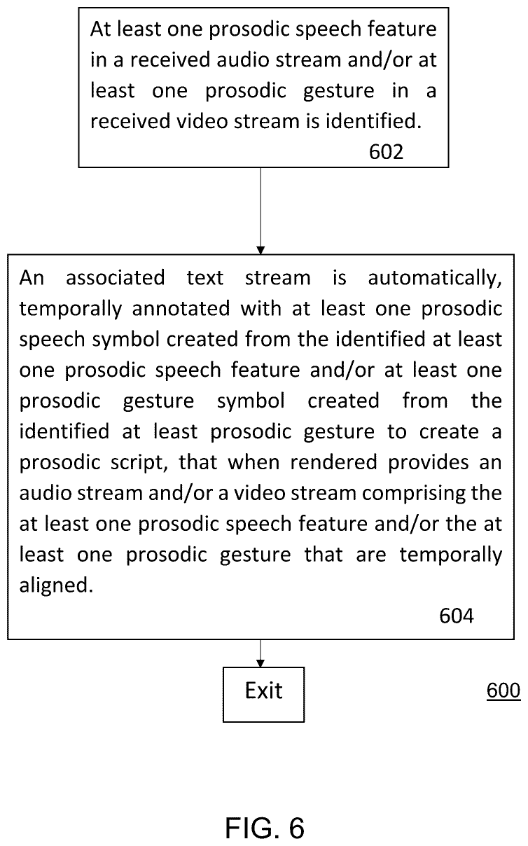

FIG. 6 depicts a flow diagram of a method 600 for creating a script for rendering audio streams and/or video streams in accordance with an embodiment of the present principles. The method 600 can begin at 602 during which at least one prosodic speech feature, in a received audio stream and/or a received language model, and/or at least one prosodic gesture in a received video stream is identified. The method 600 can proceed to 604.

At 604, an associated text stream is automatically, temporally annotated with at least one prosodic speech symbol created from the identified at least one prosodic speech feature and/or at least one prosodic gesture symbol created from the identified at least prosodic gesture to create a prosodic script, that when rendered provides an audio stream and/or a video stream comprising the at least one prosodic speech feature and/or the at least one prosodic gesture that are temporally aligned. The method 600 can then be exited.

In some embodiments, the method 600 can further include converting a received audio stream and/or a received language model into a text stream to create the associated text stream and creating the at least one prosodic speech symbol and/or the at least one prosodic gesture symbol using stored, pre-determined symbols.

In some embodiments, the method 600 can further include rendering the prosodic script to create at least one predicted audio stream and/or at least one predicted video stream and comparing prosodic speech features of the at least one predicted audio stream and/or prosodic gestures of the at least one predicted video stream to prosodic speech features of a ground truth audio stream and/or prosodic gestures of a ground truth video stream to determine respective loss functions for training a system to create the prosodic script.

In some embodiments, in the method 600 the prosodic gestures are identified from movement of at least a portion of a body of a speaker of the received audio stream.

In some embodiments, in the method 600 the portion of a body of a speaker comprises a face of the speaker of the audio stream and that at least one prosodic gesture comprises a change in at least a portion of the face of the speaker, including at least one of a head, mouth, forehead, ears, chin, or eyes of the speaker of the received audio stream.

In some embodiments, the method 600 can further include creating a spectrogram of the received audio stream, rendering the spectrogram from the prosodic script to create a predicted spectrogram, and comparing the predicted spectrogram to the created spectrogram to determine a loss function for training a system to create the prosodic script.

In some embodiments, in the method 600 the at least one prosodic speech feature comprises at least one of an emphasis, a duration, or a pitch of a temporal portion of the received audio stream.

In some embodiments of the present principles, a method for creating a dynamic prosodic script for rendering audio and/or video streams includes identifying at least one prosodic speech feature in a received audio stream and/or a received language model, creating at least one modifiable prosodic speech symbol for each of the identified at least one prosodic speech features, converting the received audio stream into a text stream, automatically and temporally annotating the text stream with at least one created, modifiable prosodic speech symbol, identifying in a received video stream at least one prosodic gesture of at least a portion of a body of a speaker of the received audio stream, creating at least one modifiable prosodic gesture symbol for each of the identified at least one prosodic gestures and temporally annotating the text stream with at least one created, modifiable prosodic gesture symbol along with the at least one modifiable, prosodic speech symbol to create a prosodic script, wherein the at least one modifiable speech prosodic symbol and the at least one modifiable prosodic gesture symbol are modifiable in the prosodic script, such that a rendering of an audio stream or a video stream from the prosodic script is changed when at least one of the at least one modifiable speech prosodic symbol and the at least one modifiable prosodic gesture symbol is modified.

In some embodiments, in the method at least one of the at least one prosodic speech symbol or the at least one prosodic gesture symbol comprise at least one of a predetermined character representative of at least one of the prosodic speech features identified in the audio stream and/or the received language model or at least one of the prosodic gestures identified in the video stream or a semantic description of at least one of the prosodic speech features identified in the audio stream and/or a received language model or at least one of the prosodic gestures identified in the video stream.

In some embodiments, an apparatus for creating a script for rendering audio and/or video streams includes a processor and a memory accessible to the processor, the memory having stored therein at least one of programs or instructions executable by the processor to configure the apparatus to identify at least one prosodic speech feature in a received audio stream and/or a received language model and/or identify at least one prosodic gesture in a received video stream, and automatically temporally annotate an associated text stream with at least one prosodic speech symbol created from the identified at least one prosodic speech feature and/or at least one prosodic gesture symbol created from the identified at least prosodic gesture to create a prosodic script, that when rendered provides an audio stream and/or a video stream comprising the at least one prosodic speech feature and/or the at least one prosodic gesture that are temporally aligned.

In some embodiments, the apparatus is further configured to convert a received audio stream and/or a received language model into a text stream to create the associated text stream, and create the at least one prosodic speech symbol and/or the at least one prosodic gesture symbol using stored, pre-determined symbols.

In some embodiments, the apparatus is further configured to render the prosodic script to create at least one predicted audio stream and/or at least one predicted video stream and compare prosodic speech features of the at least one predicted audio stream and/or prosodic gestures of the at least one predicted video stream to prosodic speech features of a ground truth audio stream and/or prosodic gestures of a ground truth video stream to determine respective loss functions for training a system to create the prosodic script.

In some embodiments, the prosodic gestures are identified from movement of at least a portion of a body of a speaker of the received audio stream.

In some embodiments, the portion of a body of a speaker comprises a face of the speaker of the audio stream and that at least one prosodic gesture comprises a change in at least a portion of the face of the speaker, including at least one of a head, mouth, forehead, ears, chin, or eyes of the speaker of the received audio stream.

In some embodiments, the apparatus is further configured to create a spectrogram of the received audio stream, render the spectrogram from the prosodic script to create a predicted spectrogram, and compare the predicted spectrogram to the created spectrogram to determine a loss function for training a system to create the prosodic script.

In some embodiments, the at least one prosodic speech feature comprises at least one of an emphasis, a duration, or a pitch of a temporal portion of the received audio stream.

In some embodiments, a system for creating a script for rendering audio and/or video streams includes a spectral features module, a gesture features module, a streams to script module, and an apparatus comprising a processor and a memory accessible to the processor, the memory having stored therein at least one of programs or instructions. In such embodiments, when the programs or instructions are executed by the processor, the apparatus is configured to identify, using the spectral features module and/or the gesture features module, at least one prosodic speech feature in a received audio stream and/or a received language model and/or identify at least one prosodic gesture in a received video stream, and automatically and temporally annotate, using the streams to script module, an associated text stream with at least one prosodic speech symbol created from the identified at least one prosodic speech feature and/or at least one prosodic gesture symbol created from the identified at least prosodic gesture to create a prosodic script, that when rendered provides an audio stream and/or a video stream comprising the at least one prosodic speech feature and/or the at least one prosodic gesture that are temporally aligned.

In some embodiments, the system further includes a speech to text module and the apparatus is further configured to convert, using the speech to text module, a received audio stream into a text stream to create the associated text stream, and create, using the streams to script module, the at least one prosodic speech symbol and/or the at least one prosodic gesture symbol using stored, pre-determined symbols.

In some embodiments, the system further includes a rendering module and the apparatus is further configured to render, using the rendering module, the prosodic script to create at least one predicted audio stream and/or at least one predicted video stream, and compare, using the rendering module, prosodic speech features of the at least one predicted audio stream and/or prosodic gestures of the at least one predicted video stream to prosodic speech features of a ground truth audio stream and/or prosodic gestures of a ground truth video stream to determine respective loss functions for training a system to create the prosodic script.

In some embodiments, the prosodic gestures are identified, by the streams to script module, from movement of at least a portion of a body of a speaker of the received audio stream.

In some embodiments, the portion of a body of a speaker includes a face of the speaker of the audio stream and that at least one prosodic gesture includes a change in at least a portion of the face of the speaker, including at least one of a head, mouth, forehead, ears, chin, or eyes of the speaker of the received audio stream.

In some embodiments, the apparatus is further configured to create a spectrogram of the received audio stream, render the spectrogram from the prosodic script to create a predicted spectrogram, and compare the predicted spectrogram to the created spectrogram to determine a loss function for training a system to create the prosodic script.

In some embodiments, the at least one prosodic speech feature comprises at least one of an emphasis, a duration, or a pitch of a temporal portion of the received audio stream.

Embodiments of the present principles can be implemented to determine prosodic scripts for training a prosodic scripting system of the present principles from actual behaving humans. Then, given input text (or in an alternative embodiment, the gist of what is to be said or a large language model), a prosodic scripting system of the present principles can predict appropriate prosodic enhancements to text, to generate a full prosodic script for a specific individual. In some embodiments, the prosodic script can then be rendered directly, but also edited, either textually or through a user interface, in order to modify the behavior of the rendering in desired ways.

In some embodiments the prosodic script can be used directly by a human actor, i.e., to provide guidance to the actor on desired behaviors.

In some embodiments, the prosodic script can be extracted from actual human behavior, and the prosodic script can be used to find markers for either undesirable or pathological behavior. For example, excessive frowning or eye-wandering can be revealed to the user in a biofeedback-type style or can be measured and reported to a clinician for evaluation (e.g., of autism spectrum disorder, speech disorders, etc.).

In some embodiments, a prosodic scripting system of the present principles can be used to edit real performances. That is, one can record a performance, use the system to generate a prosodic script, modify the prosodic script in selected spots to modify specific aspects of that performance, and then render the complete performance again, with the modified portions included, seamlessly integrated with the original performance elements. In some embodiments, the modified elements can be rendered in the style of a recorded actor, based on current or previous training data for that person, for example in a received large language model.

In some embodiments, however, for humorous or artistic effects, the styles from other subject models can be used instead. Alternatively or in addition, in some embodiments, dynamics can also be edited at a lower level (e.g., position of a facial feature or intensity of the voice at each moment in time), rather than at the sequence level that incorporates the predictions of individual styles.

In some embodiments, a user of a prosodic scripting system of the present principles can take advantage of the system's ability to randomly vary the rendering using modifiable prosodic symbols within a believable range for that subject. Then, for example, the user can record a performance, watch various renderings of that performance with, for example, subtle modifications of motions and tone, and then select a desired rendering and/or prosodic script.

Embodiments of a prosodic scripting system of the present principles enable a creation of audio and video streams that more closely match an actor's or director's intentions.

As depicted in FIG. 1, embodiments of a prosodic scripting system of the present principles, such as the prosodic scripting system 100 of FIG. 1, can be implemented in a computing device 700 in accordance with the present principles. That is, in some embodiments, audio and video data of, for example, a human reciting a monologue and the like, can be communicated to, for example, the spectral features module 105 and the visual features module 110 of the prosodic scripting system 100 using the computing device 700 via, for example, any input/output means associated with the computing device 700. Data associated with a prosodic scripting system in accordance with the present principles can be presented to a user using an output device of the computing device 700, such as a display, a printer or any other form of output device.

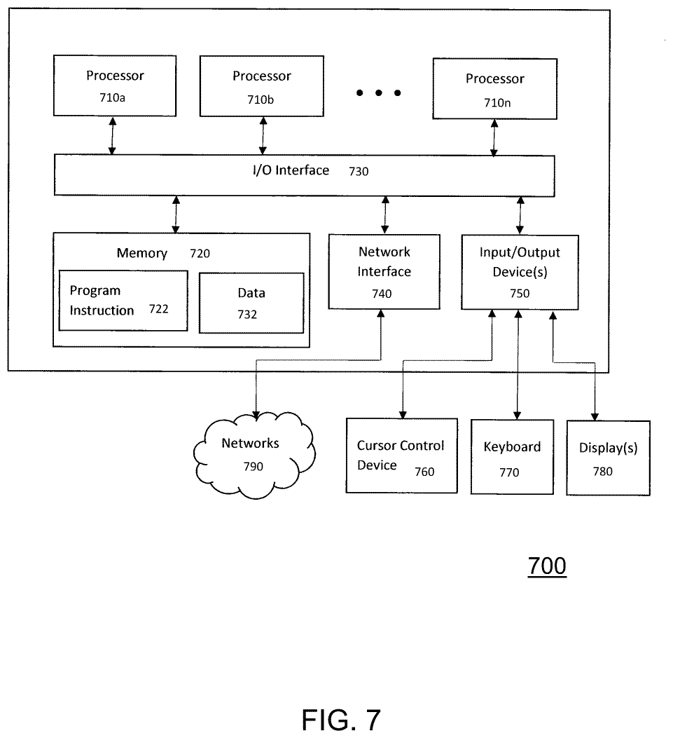

For example, FIG. 7 depicts a high-level block diagram of a computing device 700 suitable for use with embodiments of a prosodic scripting system in accordance with the present principles such as the prosodic scripting system 100 of FIG. 1. In some embodiments, the computing device 700 can be configured to implement methods of the present principles as processor-executable executable program instructions 722 (e.g., program instructions executable by processor(s) 710) in various embodiments.

In the embodiment of FIG. 7, the computing device 700 includes one or more processors 710a-710n coupled to a system memory 720 via an input/output (I/O) interface 730. The computing device 700 further includes a network interface 740 coupled to I/O interface 730, and one or more input/output devices 750, such as cursor control device 760, keyboard 770, and display(s) 780. In various embodiments, a user interface can be generated and displayed on display 780. In some cases, it is contemplated that embodiments can be implemented using a single instance of computing device 700, while in other embodiments multiple such systems, or multiple nodes making up the computing device 700, can be configured to host different portions or instances of various embodiments. For example, in one embodiment some elements can be implemented via one or more nodes of the computing device 700 that are distinct from those nodes implementing other elements. In another example, multiple nodes may implement the computing device 700 in a distributed manner.

In different embodiments, the computing device 700 can be any of various types of devices, including, but not limited to, a personal computer system, desktop computer, laptop, notebook, tablet or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, the computing device 700 can be a uniprocessor system including one processor 710, or a multiprocessor system including several processors 710 (e.g., two, four, eight, or another suitable number). Processors 710 can be any suitable processor capable of executing instructions. For example, in various embodiments processors 710 may be general-purpose or embedded processors implementing any of a variety of instruction set architectures (ISAs). In multiprocessor systems, each of processors 710 may commonly, but not necessarily, implement the same ISA.

System memory 720 can be configured to store program instructions 722 and/or data 732 accessible by processor 710. In various embodiments, system memory 720 can be implemented using any suitable memory technology, such as static random-access memory (SRAM), synchronous dynamic RAM (SDRAM), nonvolatile/Flash-type memory, or any other type of memory. In the illustrated embodiment, program instructions and data implementing any of the elements of the embodiments described above can be stored within system memory 720. In other embodiments, program instructions and/or data can be received, sent or stored upon different types of computer-accessible media or on similar media separate from system memory 720 or computing device 700.

In one embodiment, I/O interface 730 can be configured to coordinate I/O traffic between processor 710, system memory 720, and any peripheral devices in the device, including network interface 740 or other peripheral interfaces, such as input/output devices 750. In some embodiments, I/O interface 730 can perform any necessary protocol, timing or other data transformations to convert data signals from one component (e.g., system memory 720) into a format suitable for use by another component (e.g., processor 710). In some embodiments, I/O interface 730 can include support for devices attached through various types of peripheral buses, such as a variant of the Peripheral Component Interconnect (PCI) bus standard or the Universal Serial Bus (USB) standard, for example. In some embodiments, the function of I/O interface 730 can be split into two or more separate components, such as a north bridge and a south bridge, for example. Also, in some embodiments some or all of the functionality of I/O interface 730, such as an interface to system memory 720, can be incorporated directly into processor 710.

Network interface 740 can be configured to allow data to be exchanged between the computing device 700 and other devices attached to a network (e.g., network 790), such as one or more external systems or between nodes of the computing device 700. In various embodiments, network 790 can include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 740 can support communication via wired or wireless general data networks, such as any suitable type of Ethernet network, for example; via digital fiber communications networks; via storage area networks such as Fiber Channel SANs, or via any other suitable type of network and/or protocol.

Input/output devices 750 can, in some embodiments, include one or more display terminals, keyboards, keypads, touchpads, scanning devices, voice or optical recognition devices, or any other devices suitable for entering or accessing data by one or more computer systems. Multiple input/output devices 750 can be present in computer system or can be distributed on various nodes of the computing device 700. In some embodiments, similar input/output devices can be separate from the computing device 700 and can interact with one or more nodes of the computing device 700 through a wired or wireless connection, such as over network interface 740.

Those skilled in the art will appreciate that the computing device 700 is merely illustrative and is not intended to limit the scope of embodiments. In particular, the computer system and devices can include any combination of hardware or software that can perform the indicated functions of various embodiments, including computers, network devices, Internet appliances, PDAs, wireless phones, pagers, and the like. The computing device 700 can also be connected to other devices that are not illustrated, or instead can operate as a stand-alone system. In addition, the functionality provided by the illustrated components can in some embodiments be combined in fewer components or distributed in additional components. Similarly, in some embodiments, the functionality of some of the illustrated components may not be provided and/or other additional functionality can be available.

The computing device 700 can communicate with other computing devices based on various computer communication protocols such a Wi-Fi, Bluetooth.RTM. (and/or other standards for exchanging data over short distances includes protocols using short-wavelength radio transmissions), USB, Ethernet, cellular, an ultrasonic local area communication protocol, etc. The computing device 700 can further include a web browser.

Although the computing device 700 is depicted as a general-purpose computer, the computing device 700 is programmed to perform various specialized control functions and is configured to act as a specialized, specific computer in accordance with the present principles, and embodiments can be implemented in hardware, for example, as an application specified integrated circuit (ASIC). As such, the process steps described herein are intended to be broadly interpreted as being equivalently performed by software, hardware, or a combination thereof.

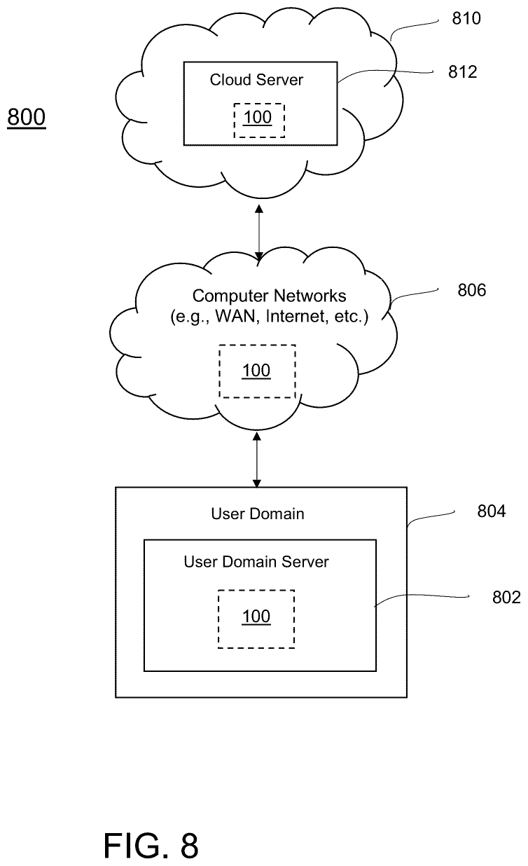

FIG. 8 depicts a high-level block diagram of a network in which embodiments of a prosodic scripting system in accordance with the present principles, such as the prosodic scripting system 100 of FIG. 1, can be applied. The network environment 800 of FIG. 8 illustratively comprises a user domain 802 including a user domain server/computing device 804. The network environment 800 of FIG. 8 further comprises computer networks 806, and a cloud environment 810 including a cloud server/computing device 812.

In the network environment 800 of FIG. 8, a system for prosodic scripting in accordance with the present principles, such as the system 100 of FIG. 1, can be included in at least one of the user domain server/computing device 804, the computer networks 806, and the cloud server/computing device 812. That is, in some embodiments, a user can use a local server/computing device (e.g., the user domain server/computing device 804) to provide prosodic scripts in accordance with the present principles.

In some embodiments, a user can implement a system for prosodic scripting in the computer networks 806 to provide prosodic scripts in accordance with the present principles. Alternatively or in addition, in some embodiments, a user can implement a system for prosodic scripting in the cloud server/computing device 812 of the cloud environment 810 in accordance with the present principles. For example, in some embodiments it can be advantageous to perform processing functions of the present principles in the cloud environment 810 to take advantage of the processing capabilities and storage capabilities of the cloud environment 810. In some embodiments in accordance with the present principles, a system for providing prosodic scripting in a container network can be located in a single and/or multiple locations/servers/computers to perform all or portions of the herein described functionalities of a system in accordance with the present principles. For example, in some embodiments components of the prosodic scripting system, such as spectral features module 105, a visual features module 110 (illustratively a facial features module), a speech to text module 115, a streams to script module 120, and a script to speech and sketch prediction module 125 can be located in one or more than one of the user domain 802, the computer network environment 806, and the cloud environment 810 for providing the functions described above either locally or remotely.

Those skilled in the art will also appreciate that, while various items are illustrated as being stored in memory or on storage while being used, these items or portions of them can be transferred between memory and other storage devices for purposes of memory management and data integrity. Alternatively, in other embodiments some or all of the software components can execute in memory on another device and communicate with the illustrated computer system via inter-computer communication. Some or all of the system components or data structures can also be stored (e.g., as instructions or structured data) on a computer-accessible medium or a portable article to be read by an appropriate drive, various examples of which are described above. In some embodiments, instructions stored on a computer-accessible medium separate from the computing device 700 can be transmitted to the computing device 700 via transmission media or signals such as electrical, electromagnetic, or digital signals, conveyed via a communication medium such as a network and/or a wireless link. Various embodiments can further include receiving, sending or storing instructions and/or data implemented in accordance with the foregoing description upon a computer-accessible medium or via a communication medium. In general, a computer-accessible medium can include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods and processes described herein may be implemented in software, hardware, or a combination thereof, in different embodiments. In addition, the order of methods can be changed, and various elements can be added, reordered, combined, omitted or otherwise modified. All examples described herein are presented in a non-limiting manner. Various modifications and changes can be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances can be provided for components described herein as a single instance. Boundaries between various components, operations and data stores are somewhat arbitrary, and particular operations are illustrated in the context of specific illustrative configurations. Other allocations of functionality are envisioned and can fall within the scope of claims that follow. Structures and functionality presented as discrete components in the example configurations can be implemented as a combined structure or component. These and other variations, modifications, additions, and improvements can fall within the scope of embodiments as defined in the claims that follow.

In the foregoing description, numerous specific details, examples, and scenarios are set forth in order to provide a more thorough understanding of the present disclosure. It will be appreciated, however, that embodiments of the disclosure can be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described can include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure can be implemented in hardware, firmware, software, or any combination thereof. Embodiments can also be implemented as instructions stored using one or more machine-readable media, which may be read and executed by one or more processors. A machine-readable medium can include any mechanism for storing or transmitting information in a form readable by a machine (e.g., a computing device or a “virtual machine” running on one or more computing devices). For example, a machine-readable medium can include any suitable form of volatile or non-volatile memory.

In addition, the various operations, processes, and methods disclosed herein can be embodied in a machine-readable medium and/or a machine accessible medium/storage device compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium/storage device.

Modules, data structures, and the like defined herein are defined as such for ease of discussion and are not intended to imply that any specific implementation details are required. For example, any of the described modules and/or data structures can be combined or divided into sub-modules, sub-processes or other units of computer code or data as can be required by a particular design or implementation.

In the drawings, specific arrangements or orderings of schematic elements can be shown for ease of description. However, the specific ordering or arrangement of such elements is not meant to imply that a particular order or sequence of processing, or separation of processes, is required in all embodiments. In general, schematic elements used to represent instruction blocks or modules can be implemented using any suitable form of machine-readable instruction, and each such instruction can be implemented using any suitable programming language, library, application-programming interface (API), and/or other software development tools or frameworks. Similarly, schematic elements used to represent data or information can be implemented using any suitable electronic arrangement or data structure. Further, some connections, relationships or associations between elements can be simplified or not shown in the drawings so as not to obscure the disclosure.

This disclosure is to be considered as exemplary and not restrictive in character, and all changes and modifications that come within the guidelines of the disclosure are desired to be protected.

1. A method for creating a script for rendering audio and/or video streams, comprising:
identifying at least one prosodic speech feature, in at least one of a received audio stream or a received language model, and/or at least one prosodic gesture in a received video stream; and
automatically temporally annotating an associated text stream with at least one prosodic speech symbol created from the identified at least one prosodic speech feature and/or at least one prosodic gesture symbol created from the identified at least prosodic gesture to create a prosodic script, that when rendered, provides an audio stream and/or a video stream comprising the at least one prosodic speech feature and/or the at least one prosodic gesture that are temporally aligned.

2. The method of claim 1, further comprising:
converting a received audio stream and/or language model into a text stream to create the associated text stream; and
creating the at least one prosodic speech symbol and/or the at least one prosodic gesture symbol using stored, pre-determined symbols.

3. The method of claim 1, further comprising
rendering the prosodic script to create at least one predicted audio stream and/or at least one predicted video stream; and
comparing prosodic speech features of the at least one predicted audio stream and/or prosodic gestures of the at least one predicted video stream to prosodic speech features of a ground truth audio stream and/or prosodic gestures of a ground truth video stream to determine respective loss functions for training a system to create the prosodic script.

4. The method of claim 1, wherein the prosodic gestures are identified from movement of at least a portion of a body of a speaker of the received audio stream.

5. The method of claim 4, wherein the portion of a body of a speaker comprises a face of the speaker of the audio stream and that at least one prosodic gesture comprises a change in at least a portion of the face of the speaker, including at least one of a head, mouth, forehead, ears, chin, or eyes of the speaker of the received audio stream.

6. The method of claim 1, further comprising;
creating a spectrogram of the received audio stream;
rendering the spectrogram from the prosodic script to create a predicted spectrogram; and
comparing the predicted spectrogram to the created spectrogram to determine a loss function for training a system to create the prosodic script.

7. The method of claim 1, wherein the at least one prosodic speech feature comprises at least one of an emphasis, a duration, or a pitch of a temporal portion of the received audio stream.

8. An apparatus for creating a script for rendering audio and/or video streams, comprising:
a processor; and
a memory accessible to the processor, the memory having stored therein at least one of programs or instructions executable by the processor to configure the apparatus to:
identify at least one prosodic speech feature, in at least one of a received audio stream or a received language model, and/or at least one prosodic gesture in a received video stream; and
automatically temporally annotate an associated text stream with at least one prosodic speech symbol created from the identified at least one prosodic speech feature and/or at least one prosodic gesture symbol created from the identified at least prosodic gesture to create a prosodic script, that when rendered, provides an audio stream and/or a video stream comprising the at least one prosodic speech feature and/or the at least one prosodic gesture that are temporally aligned.

9. The apparatus of claim 8, wherein the apparatus is further configured to:
convert a received audio stream and/or language model into a text stream to create the associated text stream; and
create the at least one prosodic speech symbol and/or the at least one prosodic gesture symbol using stored, pre-determined symbols.

10. The apparatus of claim 8, wherein the apparatus is further configured to:
render the prosodic script to create at least one predicted audio stream and/or at least one predicted video stream; and
compare prosodic speech features of the at least one predicted audio stream and/or prosodic gestures of the at least one predicted video stream to prosodic speech features of a ground truth audio stream and/or prosodic gestures of a ground truth video stream to determine respective loss functions for training a system to create the prosodic script.

11. The apparatus of claim 8, wherein the prosodic gestures are identified from movement of at least a portion of a body of a speaker of the received audio stream.

12. The apparatus of claim 11, wherein the portion of a body of a speaker comprises a face of the speaker of the audio stream and that at least one prosodic gesture comprises a change in at least a portion of the face of the speaker, including at least one of a head, mouth, forehead, ears, chin, or eyes of the speaker of the received audio stream.

13. The apparatus of claim 8, wherein the apparatus is further configured to:
create a spectrogram of the received audio stream;
render the spectrogram from the prosodic script to create a predicted spectrogram; and
compare the predicted spectrogram to the created spectrogram to determine a loss function for training a system to create the prosodic script.

14. The apparatus of claim 8, wherein the at least one prosodic speech feature comprises at least one of an emphasis, a duration, or a pitch of a temporal portion of the received audio stream.

15. A system for creating a script for rendering audio and/or video streams, comprising:
a spectral features module;
a gesture features module;
a streams to script module; and
an apparatus comprising a processor and a memory accessible to the processor, the memory having stored therein at least one of programs or instructions executable by the processor to configure the apparatus to:
identify, using the spectral features module and/or the gesture features module, at least one prosodic speech feature, in at least one of a received audio stream or a received language model, and/or at least one prosodic gesture in a received video stream; and
automatically temporally annotate, using the streams to script module, an associated text stream with at least one prosodic speech symbol created from the identified at least one prosodic speech feature and/or at least one prosodic gesture symbol created from the identified at least prosodic gesture to create a prosodic script, that when rendered, provides an audio stream and/or a video stream comprising the at least one prosodic speech feature and/or the at least one prosodic gesture that are temporally aligned.

16. The system of claim 15, further comprising a speech to text module and wherein the apparatus is further configured to:
convert, using the speech to text module, a received audio stream and/or a received language model into a text stream to create the associated text stream; and
create, using the streams to script module, the at least one prosodic speech symbol and/or the at least one prosodic gesture symbol using stored, pre-determined symbols.

17. The system of claim 15, further comprising a rendering module and wherein the apparatus is further configured to:
render, using the rendering module, the prosodic script to create at least one predicted audio stream and/or at least one predicted video stream; and
compare, using the rendering module, prosodic speech features of the at least one predicted audio stream and/or prosodic gestures of the at least one predicted video stream to prosodic speech features of a ground truth audio stream and/or prosodic gestures of a ground truth video stream to determine respective loss functions for training a system to create the prosodic script.

18. The system of claim 15, wherein the prosodic gestures are identified, by the streams to script module, from movement of at least a portion of a body of a speaker of the received audio stream.

19. The system of claim 18, wherein the portion of a body of a speaker comprises a face of the speaker of the audio stream and that at least one prosodic gesture comprises a change in at least a portion of the face of the speaker, including at least one of a head, mouth, forehead, ears, chin, or eyes of the speaker of the received audio stream.

20. The system of claim 15, wherein the apparatus is further configured to:
create a spectrogram of the received audio stream;
render the spectrogram from the prosodic script to create a predicted spectrogram; and
compare the predicted spectrogram to the created spectrogram to determine a loss function for training a system to create the prosodic script.

21. The system of claim 15, wherein the at least one prosodic speech feature comprises at least one of an emphasis, a duration, or a pitch of a temporal portion of the received audio stream.

22. A method for creating a dynamic prosodic script for rendering audio and/or video streams, comprising:
identifying at least one prosodic speech feature in a received audio stream and/or a received language model;
creating at least one modifiable prosodic speech symbol for each of the identified at least one prosodic speech features;
converting the received audio stream and/or the language model into a text stream;
automatically, temporally annotating the text stream with at least one created, modifiable prosodic speech symbol;
identifying in a received video stream at least one prosodic gesture of at least a portion of a body of a speaker of the received audio stream;
creating at least one modifiable prosodic gesture symbol for each of the identified at least one prosodic gestures; and
temporally and automatically annotating the text stream with at least one created, modifiable prosodic gesture symbol along with the at least one modifiable, prosodic speech symbol to create a prosodic script, wherein the at least one modifiable prosodic speech symbol and the at least one modifiable prosodic gesture symbol are modifiable in the prosodic script, such that a rendering of an audio stream or a video stream from the prosodic script is changed when at least one of the at least one modifiable prosodic speech symbol and the at least one modifiable prosodic gesture symbol is modified.

23. The method of claim 22, wherein at least one of the at least one prosodic speech symbol and/or the at least one prosodic gesture symbol comprise at least one of a predetermined character representative of at least one of the prosodic speech features identified in the audio stream and/or at least one of the prosodic gestures identified in the video stream or a semantic description of at least one of the prosodic speech features identified in the audio stream and/or at least one of the prosodic gestures identified in the video stream.

24. The method of claim 22, wherein the at least one prosodic speech feature is identified from a change in a normal speech of a speaker of the audio stream and the at least one prosodic gesture is identified from a change in a position of the at least portion of the body of the speaker.
